(19) United States
(12) Patent Application Publication
(10) Pub. No.: US 2024/0020293 A1
(43) Pub. Date: Jan. 18, 2024

(54) SYSTEMS AND METHODS FOR ANALYSING SOFTWARE PRODUCTS

(71) Applicant: Tata Consultancy Services Limited, Mumbai (IN)

(72) Inventors: SARJINDER SINGH SETHI, Bangalore (IN); SUBHRANSHU KUMAR SAHOO, Bhubaneswar (IN); BRAJESH SINGH, Mumbai (IN)

(73) Assignee: Tata Consultancy Services Limited, Mumbai (IN)

(21) Appl. No.: 18/473,895

(22) Filed: Sep. 25, 2023

Related U.S. Application Data
(63) Continuation-in-part of application No. 16/022,079, filed on Jun. 28, 2018, now Pat. No. 11,816,190.

(30) Foreign Application Priority Data
Jun. 30, 2017 (IN) 201721011464

(51) Int. Cl. G06F 16/23; G06F 16/28; G06F 16/25

(52) U.S. Cl. CPC G06F 16/2365; G06F 16/285; G06F 16/258

(57) ABSTRACT

Considering the number of OSS components and the number of OSS license types available today, the number of license attributes to be considered for analyzing a product at a granular level is a challenge to perform manually, prudently considering legal implications of non-compliance and contamination and also within the limited time available today before going to market in the software industry. Systems and methods of the present disclosure intelligently facilitates a matrix which is able to identify OSS components in a software product and also facilitates the product owner to identify proprietary IP that can be suitably protected and licensed without contamination by the accompanying OSS components and generated components in the software product under consideration. License attributes of the OSS components are mapped suitably, and a final attribute is derived for each OSS component embedded in the product under consideration.

### PRIORITY CLAIM

This U.S. patent application is a continuation in part of U.S. patent application Ser. No. 16/022,079, filed on Jun. 28, 2018, which claims priority under 35 U.S.C. § 119 to: Indian Patent Application No. 201721011464, filed on Jun. 30, 2017. The entire contents of the aforementioned applications are incorporated herein by reference.

### TECHNICAL FIELD

This disclosure relates generally to open source compliance management, and, more particularly to systems and methods for analyzing software products.

### BACKGROUND

Use of Open source software (OSS) involves compliance with associated licenses that define specific rights made available by the copyright holder of OSS. Such compliance implies compliance with conditions associated with each component of OSS including fragments or sub-components. Currently there are approximately more than 1.2 million OSS components available under more than 2000 OSS license types. The large volume makes it challenging to analyze the OSS components technically and legally while developing a proprietary product and ensure OSS compliance at software packaging level, delivery level and compilation level.

### SUMMARY

Embodiments of the present disclosure present technological improvements as solutions to one or more of the above-mentioned technical problems recognized by the inventors in conventional systems.

In an aspect, there is provided a processor implemented method comprising: receiving, a product under consideration embedded with one or more Open Source Software (OSS) components; comparing each of the one or more OSS components in the product under consideration with OSS components available in the public domain and comprised in a first OSS database (DB1) to identify one or more matches therebetween based on attributes associated thereof; categorizing, the one or more OSS components in the product under consideration having a match with the OSS components available in the first OSS database (DB1) as (i) OSS components having a strong copyleft license, (ii) OSS components having a permissive license or (iii) OSS components having a weak copyleft; identifying a usage type for the one or more OSS components in the product under consideration categorized as having the weak copyleft license and the permissive license, wherein the license usage type is one of a snippet, a file or a library and wherein the library is further identified as one of a library-executable or a library-binary; identifying as one or more unidentified components, the one or more OSS components in the product under consideration having no match with the OSS components available in the first OSS database (DB1) or having a match but characterized by at least one missing attribute; periodically comparing the one or more unidentified components with the OSS components in the first OSS database (DB1) to identify one or more new matches based on continual updation of OSS components available in the public domain; updating a second OSS database (DB2) comprising at least some of the one or more OSS components in the product under consideration having the one or more matches, the one or more new matches, the one or more unidentified components categorized as one or more proprietary components and OSS components previously available in the public domain; performing an OSS compliance analyses for the one or more OSS components in the product under consideration based on the usage type, the attributes associated thereof comprised in the second OSS database (DB2) and one or more pre-defined rules; and generating a comprehensive report (R5) based on the OSS compliance analyses, wherein the comprehensive report (R5) includes a final attribute for each of the one or more OSS components in the product under consideration indicative of compliance with the attributes of each of the one or more OSS components comprised therein.

In another aspect, there is provided a system comprising: one or more data storage devices operatively coupled to the one or more processors and configured to store instructions configured for execution by the one or more processors to: receive, a product under consideration embedded with one or more Open Source Software (OSS) components; compare each of the one or more OSS components in the product under consideration with OSS components available in the public domain and comprised in a first OSS database (DB1) to identify one or more matches therebetween based on attributes associated thereof; categorize, the one or more OSS components in the product under consideration having a match with the OSS components available in the first OSS database (DB1) as (i) OSS components having a strong copyleft license, (ii) OSS components having a permissive license or (iii) OSS components having a weak copyleft; identify a usage type for the one or more OSS components in the product under consideration categorized as having the weak copyleft license and the permissive license, wherein the license usage type is one of a snippet, a file or a library and wherein the library is further identified as one of a library-executable or a library-binary; identify as one or more unidentified components, the one or more OSS components in the product under consideration having no match with the OSS components available in the first OSS database (DB1) or having a match but characterized by at least one missing attribute; periodically compare the one or more unidentified components with the OSS components in the first OSS database (DB1) to identify one or more new matches based on continual updation of OSS components available in the public domain; update a second OSS database (DB2) comprising the one or more OSS components in the product under consideration having the one or more matches, the one or more new matches, the one or more unidentified components categorized as one or more proprietary components and OSS components previously available in the public domain; perform an OSS compliance analyses for the one or more OSS components in the product under consideration based on the usage type, the attributes associated thereof comprised in the second OSS database (DB2) and one or more pre-defined rules; and generate a comprehensive report (R5) based on the OSS compliance analyses, wherein the comprehensive report (R5) includes a final attribute for each of the one or more OSS components in the product under consideration indicative of compliance with the attributes of each of the one or more OSS components comprised therein.

In yet another aspect, there is provided a computer program product comprising a non-transitory computer readable medium having a computer readable program embodied therein, wherein the computer readable program, when executed on a computing device, causes the computing device to: receive, a product under consideration embedded with one or more Open Source Software (OSS) components; compare each of the one or more OSS components in the product under consideration with OSS components available in the public domain and comprised in a first OSS database (DB1) to identify one or more matches therebetween based on attributes associated thereof; categorize, the one or more OSS components in the product under consideration having a match with the OSS components available in the first OSS database (DB1) as (i) OSS components having a strong copyleft license, (ii) OSS components having a permissive license or (iii) OSS components having a weak copyleft; identify a usage type for the one or more OSS components in the product under consideration categorized as having the weak copyleft license and the permissive license, wherein the license usage type is one of a snippet, a file or a library and wherein the library is further identified as one of a library-executable or a library-binary; identify as one or more unidentified components, the one or more OSS components in the product under consideration having no match with the OSS components available in the first OSS database (DB1) or having a match but characterized by at least one missing attribute; periodically compare the one or more unidentified components with the OSS components in the first OSS database (DB1) to identify one or more new matches based on continual updation of OSS components available in the public domain; update a second OSS database (DB2) comprising the one or more OSS components in the product under consideration having the one or more matches, the one or more new matches, the one or more unidentified components categorized as one or more proprietary components and OSS components previously available in the public domain; perform an OSS compliance analyses for the one or more OSS components in the product under consideration based on the usage type, the attributes associated thereof comprised in the second OSS database (DB2) and one or more pre-defined rules; and generate a comprehensive report (R5) based on the OSS compliance analyses, wherein the comprehensive report (R5) includes a final attribute for each of the one or more OSS components in the product under consideration indicative of compliance with the attributes of each of the one or more OSS components comprised therein.

In an embodiment of the present disclosure, the one or more hardware processors are further configured to generate one or more reports comprising: a first report (R1) pertaining to the one or more unidentified components; a second report (R2) pertaining to the one or more OSS components in the product under consideration having the strong copyleft license; a third report (R3) pertaining to the one or more OSS components in the product under consideration having the weak copyleft license; and a fourth report (R4) pertaining to the one or more OSS components in the product under consideration having the permissive license.

In an embodiment of the present disclosure, the one or more hardware processors are further configured to adaptively learn the one or more OSS components and the attributes associated thereof comprised in the comprehensive report (R5) and update the second OSS database (DB2).

In an embodiment of the present disclosure, at least the second OSS database (DB2) has a pre-defined format comprising the attributes including OSS component name, OSS component version, OSS component home page URL, OSS component license type, OSS component license URL, OSS component attribution note, license usage type, commercial distribution permission, OSS component compile permission, license compatibility with the OSS component license type associated with other OSS components comprised in the product or compatibility with proprietary license.

In an embodiment of the present disclosure, the one or more hardware processors are further configured to perform the OSS compliance analyses by: combining the first report (R1), the second report (R2), the third report (R3) and the fourth report (R4); and generating the final attribute, wherein the one or more pre-defined rules comprise: Rule 1 wherein an OSS component is rejected if associated with the strong copy left license; Rule 2 wherein an OSS component is approved for inclusion in the second OSS database (DB2) if associated with the weak copy left license and the OSS usage type is one of the library not compiled with the product or the file not compiled with the product; Rule 3 wherein an OSS component is rejected if associated with the weak copy left license and the OSS usage type is the snippet; Rule 4 wherein an OSS component is approved for inclusion in the second OSS database (DB2) if associated with the permissive license and the OSS usage is one of the library, the snippet, or the file; and Rule 5 wherein an OSS component is rejected if associated with the weak copy left license and the OSS usage type is one of the library compiled with the product or the file compiled with the product.

For example, in one aspect, there is provided a processor implemented method for analyzing open source components in software products. The method comprises receiving a first input comprising at least one of (i) one or more Open Source Software (OSS) components, (ii) one or more code blocks comprised in a software product, and (iii) the software product embedded with the one or more OSS components; performing a first comparison of the first input with a first database (DB1) to identify a first set of matched OSS components and a first set of unidentified components; performing a second comparison of one or more unidentified components from the first set of unidentified components with at least one of (i) one or more logs of a code generation tool that generated the one or more unidentified components, (ii) one or more associated indicators comprised in the first set of unidentified components, and (iii) a third database (DB3) comprising one or more generated components suggested by a code generated tool for inclusion in the software product to obtain at least one of a first set of generated components, a second set of generated components, a third set of generated components, and a second set of unidentified components; categorizing based on licensing information, the first set of matched OSS components as (i) OSS components having a strong copyleft license, (ii) OSS components having a permissive license, or (iii) OSS components having a weak copyleft license; identifying a usage type for (i) the OSS components having a strong copyleft license, (ii) the OSS components having a permissive license, and (iii) the OSS components having a weak copyleft license; performing a compliance analysis for the first set of matched OSS components, at least one of the first set of generated components, the second set of generated components, the third set of generated components, and the second set of unidentified components based on the usage type, and one or more pre-defined rules, wherein the compliance analysis for the first set of matched OSS components is further based on one or more attributes associated thereof comprised in a second database (DB2); and generating a compliance analysis report pertaining to each of the first set of matched OSS components, and at least one of the first set of generated components, the second set of generated components, the third set of generated components and the second set of unidentified components based on the compliance analysis.

In an embodiment, the method further comprises updating the second database (DB2) with the first set of matched OSS components.

In an embodiment, the method further comprises populating the third database (DB3) with at least one of (i) the first set of generated components, and the second set of generated components, the third set of generated components and (ii) one or more generated components suggested by the code generated tool and accepted for inclusion in the software product.

In an embodiment, a third comparison of the first set of unidentified components with the third database (DB3) is performed to identify a fourth set of generated components, and a third set of unidentified components.

In an embodiment, the method further comprises performing a fourth comparison of one or more unidentified components from the third set of unidentified components with at least one of (i) one or more logs of the code generation tool that generated the one or more unidentified components, and (ii) the one or more associated indicators comprised in the third set of unidentified components, to obtain a fifth set of generated components and a fourth set of unidentified components.

In an embodiment, the code generation tool comprises at least one of a generative artificial intelligence (AI) model, a model-driven generation tool, and a grammar-driven generation tool.

In an embodiment, the one or more generated components suggested by the code generated tool and accepted for inclusion in the software product are detected during a software product development.

In an embodiment, the method further comprises detecting during a software product development, a dependency scenario, and a project type for one or more associated OSS components and querying the first database (DB1) to update the second database (DB2) with information relating to license type and usage type of OSS components and further querying the second database (DB2) for providing one or more recommendations.

In another aspect, a method is provided comprising receiving a first input comprising of a software product, or a portion thereof; performing, a first comparison of the first input with at least one of (i) one or more logs of a code generation tool, and (ii) one or more associated indicators comprised therein, to obtain a first set of generated components and a first set of unidentified components; and performing a compliance analysis for the first set of generated components, and generating a compliance analysis report thereof.

In an embodiment, the method further comprises performing a second comparison of the first set of unidentified components with a first database (DB1) to identify a first set of matched OSS components and a second set of unidentified components; categorizing based on licensing information, the first set of matched OSS components as (i) OSS components having a strong copyleft license, (ii) OSS components having a permissive license, or (iii) OSS components having a weak copyleft license; identifying a usage type for (i) the OSS components having a strong copyleft license, (ii) the OSS components having a permissive license, and (iii) the OSS components having a weak copyleft license; performing a compliance analysis for the first set of matched OSS components and the second set of unidentified components based on the usage type, and one or more pre-defined rules, wherein the compliance analysis for the first set of matched OSS components is further based on one or more attributes associated thereof comprised in a second database (DB2); and generating a compliance analysis report pertaining to each of the first set of matched OSS components, and the second set of unidentified components based on the compliance analysis.

In an embodiment, the code generation tool comprises at least one of a generative artificial intelligence (AI) model, a model-driven generation tool, and a grammar-driven generation tool.

In yet another aspect, there is provided a processor implemented system for analyzing open source components in software products. The system comprises: a memory storing instructions; one or more communication interfaces; and one or more hardware processors coupled to the memory via the one or more communication interfaces, wherein the one or more hardware processors are configured by the instructions to: receive a first input comprising at least one of (i) one or more Open Source Software (OSS) components, (ii) one or more code blocks comprised in a software product, and (iii) the software product embedded with the one or more OSS components; perform a first comparison of the first input with a first database (DB1) to identify a first set of matched OSS components and a first set of unidentified components; perform a second comparison of one or more unidentified components from the first set of unidentified components with at least one of (i) one or more logs of a code generation tool that generated the one or more unidentified components, and (ii) one or more associated indicators comprised in the first set of unidentified components, and (iii) a third database (DB3) comprising one or more generated components to obtain at least one of a first set of generated components, a second set of generated components, a third set of generated components and a second set of unidentified components; categorize based on licensing information, the first set of matched OSS components as (i) OSS components having a strong copyleft license, (ii) OSS components having a permissive license, or (iii) OSS components having a weak copyleft license; identifying a usage type for (i) the OSS components having a strong copyleft license, (ii) the OSS components having a permissive license, and (iii) the OSS components having a weak copyleft license; perform a compliance analysis for the first set of matched OSS components, and at least one of the first set of generated components, the second set of generated components, the third set of generated components and the second set of unidentified components based on the usage type, and one or more pre-defined rules, wherein the compliance analysis for the first set of matched OSS components is further based on one or more attributes associated thereof comprised in a second database (DB2); and generate a compliance analysis report pertaining to each of the first set of matched OSS components, and at least one of the first set of generated components, the second set of generated components, the third set of generated components, and the second set of unidentified components based on the compliance analysis.

In an embodiment, the one or more hardware processors are further configured by the instructions to update the second database (DB2) with the first set of matched OSS components.

In an embodiment, the one or more hardware processors are further configured by the instructions to populate a third database (DB3) with at least one of (i) the first set of generated components, (ii) the second set of generated components, (iii), the third set of generated components and (iv) the one or more generated components suggested by the code generated tool and accepted for inclusion in the software product.

In an embodiment, a third comparison of the first set of unidentified components with the third database (DB3) is performed to identify a fourth set of generated components, and a third set of unidentified components.

In an embodiment, the one or more hardware processors are further configured by the instructions to perform a fourth comparison of one or more unidentified components from the third set of unidentified components with at least one of (i) one or more logs of a code generation tool that generated the one or more unidentified components, and (ii) the one or more associated indicators comprised in the third set of unidentified components, to obtain a fifth set of generated components and a fourth set of unidentified components.

In an embodiment, the code generation tool comprises at least one of a generative artificial intelligence (AI) model, a model-driven generation tool, and a grammar-driven generation tool.

In a further aspect, a system is provided. The system comprises a memory storing instructions; one or more communication interfaces; and one or more hardware processors coupled to the memory via the one or more communication interfaces, wherein the one or more hardware processors are configured by the instructions to: receive a first input comprising of a software product, or a portion thereof; perform a first comparison of the first input with at least one of (i) one or more logs of a code generation tool, and (ii) one or more associated indicators comprised in the first input, to obtain a first set of generated components, a second set of generated components, and a first set of unidentified components; perform a compliance analysis for the first set of generated components, and the second set of generated components, and generate a compliance analysis report thereof.

In an embodiment, the one or more hardware processors are further configured by the instructions to perform a second comparison of the first set of unidentified components with a first database (DB1) to identify a first set of matched OSS components and a second set of unidentified components; categorize based on licensing information, the first set of matched OSS components as (i) OSS components having a strong copyleft license, (ii) OSS components having a permissive license, or (iii) OSS components having a weak copyleft license; identify a usage type for (i) the OSS components having a strong copyleft license, (ii) the OSS components having a permissive license, and (iii) the OSS components having a weak copyleft license; perform a compliance analysis for the first set of matched OSS components and the second set of unidentified components based on the usage type, and one or more pre-defined rules, wherein the compliance analysis for the first set of matched OSS components is further based on one or more attributes associated thereof comprised in a second database (DB2); and generate a compliance analysis report pertaining to each of the first set of matched OSS components, and the second set of unidentified components based on the compliance analysis.

In an embodiment, the code generation tool comprises at least one of a generative artificial intelligence (AI) model, a model-driven generation tool, and a grammar-driven generation tool.

In yet another aspect, there are provided one or more non-transitory machine-readable information storage mediums comprising one or more instructions which when executed by one or more hardware processors cause analyzing open source components in software products by receiving a first input comprising at least one of (i) one or more Open Source Software (OSS) components, (ii) one or more code blocks comprised in a software product, and (iii) the software product embedded with the one or more OSS components; performing a first comparison of the first input with a first database (DB1) to identify a first set of matched OSS components and a first set of unidentified components; performing a second comparison of one or more unidentified components from the first set of unidentified components with at least one of (i) one or more logs of a code generation tool that generated the one or more unidentified components, and (ii) one or more associated indicators comprised therein, to obtain a first set of generated components and a second set of unidentified components; categorizing based on licensing information, the first set of matched OSS components as (i) OSS components having a strong copyleft license, (ii) OSS components having a permissive license, or (iii) OSS components having a weak copyleft license; identifying a usage type for (i) the OSS components having a strong copyleft license, (ii) the OSS components having a permissive license, and (iii) the OSS components having a weak copyleft license; performing a compliance analysis for the first set of matched OSS components, the first set of generated components and the second set of unidentified components based on the usage type, and one or more pre-defined rules, wherein the compliance analysis for the first set of matched OSS components is further based on one or more attributes associated thereof comprised in a second database (DB2); and generating a compliance analysis report pertaining to each of the first set of matched OSS components, the first set of generated components and the second set of unidentified components based on the compliance analysis.

In an embodiment, the one or more instructions which when executed by one or more hardware processors further cause updating the second database (DB2) with the first set of matched OSS components.

In an embodiment, the one or more instructions which when executed by one or more hardware processors further cause populating a third database (DB3) with the first set of generated components.

In an embodiment, a third comparison of the first set of unidentified components with the third database (DB3) is performed to identify a second set of generated components, and a third set of unidentified components.

In an embodiment, the one or more instructions which when executed by one or more hardware processors further cause performing a fourth comparison of one or more unidentified components from the third set of unidentified components with at least one of (i) one or more logs of a code generation tool that generated the one or more unidentified components, and (ii) the one or more associated indicators comprised therein, to obtain a third set of generated components and a fourth set of unidentified components.

In an embodiment, the code generation tool is at least one of a generative artificial intelligence (AI) model, a model-driven generation tool, and a grammar-driven generation tool.

In yet further aspect, there are provided one or more non-transitory machine-readable information storage mediums comprising one or more instructions which when executed by one or more hardware processors cause receiving a first input comprising of a software product, or a portion thereof; performing, a first comparison of the first input with at least one of (i) one or more logs of a code generation tool, and (ii) one or more associated indicators comprised therein, to obtain a first set of generated components and a first set of unidentified components; and performing a compliance analysis for the first set of generated components, and generating a compliance analysis report thereof.

In an embodiment, the one or more instructions which when executed by one or more hardware processors further cause performing a second comparison of the first set of unidentified components with a first database (DB1) to identify a first set of matched OSS components and a second set of unidentified components; categorizing based on licensing information, the first set of matched OSS components as (i) OSS components having a strong copyleft license, (ii) OSS components having a permissive license, or (iii) OSS components having a weak copyleft license; identifying a usage type for (i) the OSS components having a strong copyleft license, (ii) the OSS components having a permissive license, and (iii) the OSS components having a weak copyleft license; performing a compliance analysis for the first set of matched OSS components and the second set of unidentified components based on the usage type, and one or more pre-defined rules, wherein the compliance analysis for the first set of matched OSS components is further based on one or more attributes associated thereof comprised in a second database (DB2); and generating a compliance analysis report pertaining to each of the first set of matched OSS components, and the second set of unidentified components based on the compliance analysis.

In an embodiment, the code generation tool is at least one of a generative artificial intelligence (AI) model, a model-driven generation tool, and a grammar-driven generation tool.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 depicts an exemplary system for analyzing open source software components, identifying generated components and proprietary components in software products, in accordance with an embodiment of the present disclosure.

FIG. 2A through FIG. 2B illustrates an exemplary flow diagram for a computer implemented method to analyze open source components in software products, in accordance with an embodiment of the present disclosure.

FIG. 3 illustrates an exemplary flow chart for the computer implemented method of FIG. 2A through FIG. 2B, in accordance with an embodiment of the present disclosure.

FIG. 4 depicts an exemplary flow chart illustrating a method for analyzing open source software components, identifying generated components and proprietary components in software products, using the system of FIG. 1, in accordance with an embodiment of the present disclosure.

FIG. 5 depicts a method for analyzing open source software components, identifying generated components and proprietary components in software products, using the system of FIG. 1, in accordance with an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Systems and methods of the present disclosure aim to overcome legal complications that may arise when using open source software (OSS) and generated components in software products. Solutions that implement open source software components are enforced by open source license terms and conditions such as General Public License (GPL), Lesser General Public License (LGPL), Massachusetts Institute of Technology (MIT) License, Berkeley Software Distribution (BSD), Apache, and the like. These open source licenses have their own attributes which specify distribution rights, sublicense rights, packaging rights, code matches, binary matches, and the like. These attributes differ depending on the license types, permissible usage, license terms, expiry of terms, scope of usage, warranty, etc. There are approximately 2000 license types in the OSS world today which govern more than 1.2 million OSS components. The number of attributes may therefore be at least 10 times more than the license types when summed. The present disclosure provides intelligence to categories of OSS components in such a manner that the systems and methods of the present disclosure can read the categorization logically and can provide appropriate compliance output.

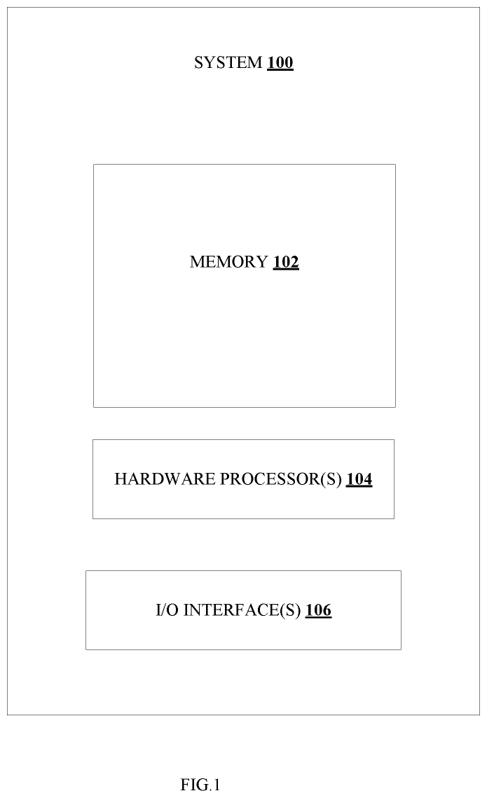

Referring now to the drawings, and more particularly to FIGS. 1 through 3 where similar reference characters denote corresponding features consistently throughout the figures, there are shown preferred embodiments and these embodiments are described in the context of the following exemplary system and/or method.

FIG. 1 depicts an exemplary system for analyzing open source components, identifying generated components and proprietary components in software products, in accordance with an embodiment of the present disclosure. Alternatively, FIG. 1 illustrates an exemplary block diagram of a system to analyze open source components in software products, in accordance with an embodiment of the present disclosure. In an embodiment, the system 100 includes one or more hardware processors 104, communication interface device(s) or input/output (I/O) interface(s) 106 (also referred as interface(s)), and one or more data storage devices or memory 102 operatively coupled to the one or more hardware processors 104. The one or more processors 104 may be one or more software processing components and/or hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is/are configured to fetch and execute computer-readable instructions stored in the memory. In an embodiment, the system 100 can be implemented in a variety of computing systems, such as laptop computers, notebooks, hand-held devices (e.g., smartphones, tablet phones, mobile communication devices, and the like), workstations, mainframe computers, servers, a network cloud, and the like.

The I/O interface device(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random-access memory (SRAM) and dynamic-random access memory (DRAM), and/or non-volatile memory, such as read only memory (ROM), erasable programmable ROM, flash memories, hard disks, optical disks, and magnetic tapes. In an embodiment, a database 108 is comprised in the memory 102. The memory 102 further comprises (or may further comprise) information pertaining to input(s)/output(s) of each step performed by the systems and methods of the present disclosure. In other words, input(s) fed at each step and output(s) generated at each step are comprised in the memory 102 and can be utilized in further processing and analysis.

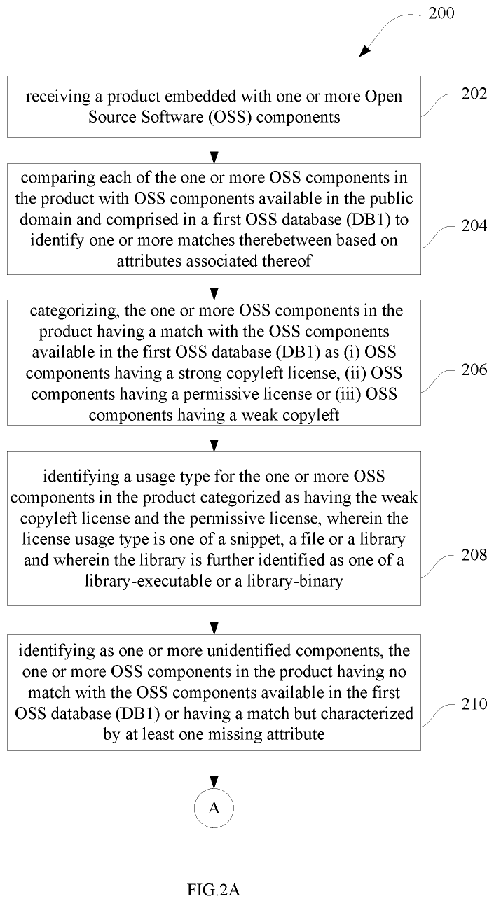

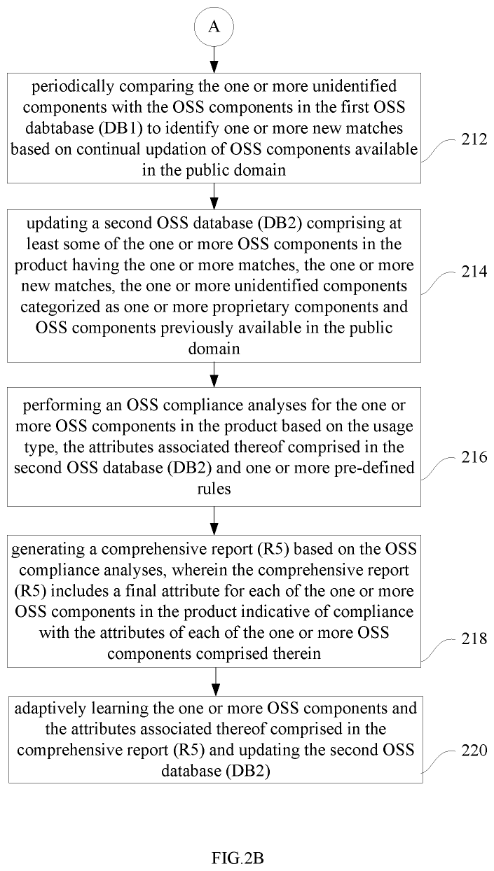

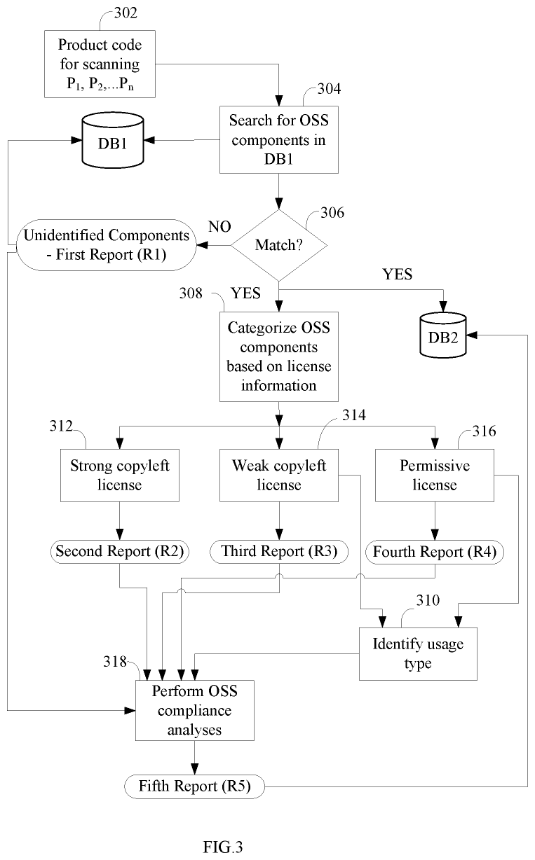

FIG. 2A through FIG. 2B illustrates an exemplary flow diagram for a computer implemented method 200 and FIG. 3 illustrates an exemplary flow chart 300 for the method 200 to analyze open source components in software products, in accordance with an embodiment of the present disclosure. In an embodiment, the system 100 includes one or more data storage devices or memory 102 operatively coupled to the one or more processors 104 and is configured to store instructions configured for execution of steps of the method 200 by the one or more processors 104. The steps of the method 200 will now be explained in detail with reference to the components of the system 100 of FIG. 1 and the components of the flow chart 300 of FIG. 3. Although process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

In an embodiment of the present disclosure, the one or more processors 104 are configured to receive, at step 202, a product under consideration embedded with one or more Open Source Software (OSS) components. It may be understood that in the context of the present disclosure, the expression ‘product’ used herein refers to a software product.

Let DB1 represent a first Open Source Software (OSS) database of OSS components available in the public domain. The first OSS database (DB1) may be available in the public domain or may be populated by the system 100 of the present disclosure based on OSS components available in the public domain. An exemplary public OSS database DB1 with OSS components having exemplary attributes may be represented as shown in Table 1 herein below.

TABLE 1

| | | | | |
|---|---|---|---|---|
| OSS | O1 | O2 | O3 | O4 |
| Component | Android-N810 | Android-Support | Android-Support | quartz-web |
| Version | | 4 | 4 | trunk-20120509-svn |
| Home | http://sourceforge.net/ | http://developer.android.com/ | http://developer.android.com/ | http://code.google.com/ |
| Page | projects/android-n810/ | tools/support-library/ | tools/support-library/ | p/quartz-web/ |
| | | setup.html#download | setup.html#download | |
| License | Apache License 2.0 | Apache License 2.0 | Apache License 2.0 | dom4j License (BSD 2.0+) |
| Types | | | | |
| License | http://www.apache.org/ | http://www.apache.org/ | http://www.apache.org/ | http://dom4j.sourceforge.net/ |
| URL | licenses/LICENSE-2.0 | licenses/LICENSE-2.0 | licenses/LICENSE-2.0 | license.html |
| Usage | Component (Dynamic Library) | File | Snippets | |
| Ship | Ship | Ship | Ship | |
| Status | | | | |
| Attribution | Copyright (C) 2012 The | ©2004-2011 The | ©2004-2011 The | Copyright 2001-2010 |
| Note | Android Open Source | Apache Software | Apache Software | (C) MetaStuff |
| | [symbol] | [symbol] | [symbol] | |

| | | | | |
|---|---|---|---|---|
| OSS | O5 | O6 | O7 | O8 |
| Component | revertools | wpadk | xstream-1.3.1.jar | anhhoang |
| Version | | | 1.3.1 | trunk- [symbol] |
| Home | http://code.google.com/ | http://wpadk.codeplex.com/ | http://central.maven.org/ | http://code.google.com/ |
| Page | p/revertools/ | | maven2/com/thoughtworks/ | p/anhhoang/ |
| | | | xstream/xstream/1.3.1/xstream- | |
| License | MIT License | Oracle JRE 6 and JavaFX Binary | Public Domain | Eclipse Public |
| Types | | Code Updated License | | License 1.0 |
| License | http://opensource.org/ | http://www.oracle.com/ | http://creativecommons.org/ | http://www.eclipse.org/ |
| URL | licenses/MIT | technetwork/java/javase/ | licenses/publicdomain/ | legal/epl-v10.html |
| | | downloads/jce-6-download- | | |
| | | 429243.html | | |
| Usage | | | | |
| Ship | | | | |
| Status | | | | |
| Attribution | Copyright © by | Copyright © 1995- | Copyright(c) by | Copyright © by |
| Note | bollton2010 | 2016, Oracle | aopalliance | anhhoang1109 |
| | | | | [symbol] |

| | | | |
|---|---|---|---|
| OSS | O9 | O10 | O11 |
| Component | Coova JRadius | easyC | MySql |
| Version | 1.0.0 | secondglimpse | |
| Home | http://www.coova.org/ | http://sourceforge.net/ | https://www.mysql.com/ |
| Page | JRadius | projects/easyc/ | downloads/ |
| License | GNU Lesser General Public | Eclipse Public | GPL |
| Types | License v3.0 or later | License 1.0 | |
| License | http://www.gnu.org/ | http://www.eclipse.org/ | https://www.gnu.org/ |
| URL | licenses/lgpl-3.0.en.html | legal/epl-v10.html | licenses/gpl-3.0.en.html |
| Usage | | | |
| Ship | | | |
| Status | | | |
| Attribution | Copyright 2006- | Copyright © 2002- | ©2016, Oracle |
| Note | 2010 Coova | 2016. | [symbol] |

[symbol]

indicates data missing or illegible when filed

In an embodiment, a product under consideration embedded with one or more Open source software (OSS) components that need to be analyzed for OSS compliance and also prevent OSS contamination of proprietary components is received by the system 100 of the present disclosure at step 202 (FIG. 2A). As seen in the flow chart of FIG. 3, different versions of a product P₁, P₂, . . . Pₙ are received at block 302. The OSS components of the product under consideration is compared at block 304 (FIG. 3) with OSS components available in the first OSS database DB1 at step 204 (FIG. 2A) to identify one or more matches therebetween based on component attributes and license attributes associated thereof. At block 306 (FIG. 3) there is check for a match, if any. In an embodiment, the one or more OSS components having a match with the OSS components available in the public OSS database (DB1) are categorized based on associated attributes at step 206 (FIG. 2A) and block 308 (FIG. 3). In an embodiment the various categories may include (i) OSS components having strong copyleft license such as General Public License (GPL) or Affero General Public License (AGPL) (ii) permissive license such as Massachusetts Institute of Technology (MIT) License or Apache or (iii) weak copyleft or free public license such as Lesser General Public License (LGPL), Mozilla Public License (MPL), Eclipse Public License (EPL) and the like.

In an embodiment, the one or more processors 104 are configured to identify, at step 208 (FIG. 2A) and block 310 (FIG. 3) a usage type for the one or more OSS components in the product under consideration categorized as having the weak copyleft license and the permissive license. In an embodiment, the license usage type may be one of a snippet, a file or a library, wherein the library may be further identified as one of a library-executable or a library-binary type.

The OSS components of the product under consideration having no match or having a match but characterized by one or more missing attributes are identified as unidentified components at step 210 (FIG. 2A) and at block 306 (FIG. 3).

The OSS components available in the public domain and comprised in the first OSS database (DB1) are updated continually based information available via the World Wide Web. Therefore, in accordance with an embodiment of the present disclosure, the one or more processors 104 are configured to periodically compare, at step 212 (FIG. 2B) the unidentified components from step 210 (FIG. 2A) and block 306 (FIG. 3) with the OSS components in the first OSS database (DB1) to identify one or more new matches.

Furthermore, in accordance with the present disclosure a customized knowledge base is adaptively learnt in the form of a second OSS database (DB2), at step 214 (FIG. 26). In an embodiment, the second OSS database (DB2) comprises the one or more matches from step 204 (FIG. 2A) and the one or more new matches from step 212 (FIG. 26). In an embodiment, the unidentified components may be categorized as proprietary components to be packaged suitable. Accordingly, in an embodiment, the second OSS database (DB2) also comprises the one or more unidentified components from step 210 (FIG. 2A) categorized as proprietary components and also OSS components previously available in the public domain.

In an embodiment, at least the second OSS database (DB2) has a pre-defined format comprising the attributes including OSS component name, OSS component version, OSS component home page URL, OSS component license type, OSS component license URL, OSS component attribution note, license usage type, commercial distribution permission, OSS component compile permission, license compatibility with the OSS component license type associated with other OSS components comprised in the product or compatibility with proprietary license. The pre-defined format is configured to facilitate faster retrieval of information comprised therein as compared to fetching information based on metadata.

In an embodiment, the second OSS database (DB2) having exemplary attributes may be represented as shown in Table 2 herein below.

TABLE 2

| | | | | |
|---|---|---|---|---|
| OSS | O1 | O2 | O3 | O4 |
| Component | hibernatecommonsannotations.jar | hibernatecommonsannotations.c | hibernatecommonsannotations.c | mchange-commons-java |
| Version | | | | 0.2.2 |
| Home Page | http://central.maven.org/ | http://central.maven.org/ | http://central.maven.org/ | http://github.com/ |
| | maven2/org/hibernate/ | maven2/org/hibernate/ | maven2/org/hibernate/ | swaldman/mchange- |
| | hibernate-commons- | hibernate-commons- | hibernate-commons- | commons-java/ |
| | annotations/3.3.0.ga/ | annotations/3.3.0.ga/ | annotations/3.3.0.ga/ | |
| | hibernate-commons-annotations- | hibernate-commons- | hibernate-commons- | |
| | 3.3.0.ga.pom | annotations-3.3.0.ga.pom | annotations-3.3.0.ga.pom | |
| License type | GNU Lesser General Public | GNU Lesser General Public | GNU Lesser General Public | General public license |
| | License v3.0 or later | License v3.0 or later | License v3.0 or later | |
| License URL | http://www.gnu.org/licenses/ | http://www.gnu.org/licenses/ | http://www.gnu.org/licenses/ | http://www.gnu.org/ |
| | lgpl-3.0.en.html | lgpl-3.0.en.html | lgpl-3.0.en.html | licenses/lgpl-2.1.html |
| Usage | Component (Dynamic Library) | File | Snippets | Component (Dynamic |
| | | | | Library) |
| Distributable | Yes | Yes | No | No |
| Attribution Note | Copyright (c) 2008, Red Hat | Copyright (c) 2008, Red Hat | Copyright (c) 2008, Red | Copyright (C) 1991, 1999 |
| | Middleware LLC | Middleware LLC | Hat Middleware LLC | Free Software Foundation, |
| | | | | [symbol] |
| Compile | No | No | No | No |
| License | Yes | No | No | No |
| compatibility | | | | |
| with proprietary | | | | |
| license/code | | | | |

| | | | | |
|---|---|---|---|---|
| OSS | O5 | O6 | O7 | O8 |
| Component | mchange-commons. Jar | Mchange.Jar | JackRabit.jar | JackRabit.jar |
| Version | 0.2.2 | 0.2.2 | 01 | 01 |
| Home Page | http://github.com/swaldman/ | http://github.com/swaldman/ | https://apachekackrabit.com | https://apachekackrabit.com |
| | mchange-commons-java/ | mchange-commons-java/ | | |
| License type | General public license | General public license | Apache license | Apache license |
| License URL | http://www.gnu.org/licenses/ | http://www.gnu.org/licenses/ | https://www.apache.org/licenses/ | https://www.apache.org/licenses/ |
| | lgpl-2.1.html | lgpl-2.1.html | LICENSE-2.0 | LICENSE-2.0 |
| Usage | File | Snippets | Component | File |
| Distributable | No | NO | Yes | Yes |
| Attribution Note | Copyright (C) 1991, 1999 | Copyright (C) 1991, 1999 | ©jackrabbit | ©jackrabbit |
| | Free Software Foundation, | Free Software Foundation, | | |
| | [symbol] | [symbol] | | |
| Compile | No | No | Yes | Yes |
| License | No | No | Yes | Yes |
| compatibility | | | | |
| with proprietary | | | | |
| license/code | | | | |

| | | | | |
|---|---|---|---|---|
| OSS | O9 | O10 | O11 | O12 |
| Component | JackRabit.jar | Firefox.jar | Flipbox.java | Flipbox.c |
| Version | 01 | 11 | 11 | 11 |
| Home Page | https://apachekackrabit.com | Firefox.com | Flipbox.com | Flipbox.com |
| License type | Apache license | Mozilla license | Mozilla license | Mozilla license |
| License URL | https://www.apache.org/ | https://en.wikipedia.org/ | https://en.wikipedia.org/ | https://en.wikipedia.org/ |
| | licenses/LICENSE-2.0 | wiki/Mozilla_Public_License | wiki/Mozilla_Public_License | wiki/Mozilla_Public_License |
| Usage | Snippet | Component | File | File |
| Distributable | Yes | Yes | No | No |
| Attribution Note | ©jackrabbit | ©Mozilla | ©Flipbox | ©Flipbox |
| Compile | Yes | Yes | No | No |
| License | Yes | Yes | No | No |
| compatibility | | | | |
| with proprietary | | | | |
| license/code | | | | |

[symbol]

indicates data missing or illegible when filed

In an embodiment, the one or more processors 104 are configured to generate one or more reports, at step 222. For instance, post identification of the unidentified components at step 210 (FIG. 2A), a first report (R1) pertaining to the one or more unidentified components may be generated at block 306 (FIG. 3); a second report (R2) pertaining to the pertaining to the one or more OSS components in the product under consideration having the strong copyleft license may be generated at block 312 (FIG. 3); a third report (R3) pertaining to the one or more OSS components in the product under consideration having the weak copyleft license may be generated at block 314 (FIG. 3); and a fourth report (R4) pertaining to the one or more OSS components in the product under consideration having the permissive license may be generated at block 316 (FIG. 3).

In an embodiment, the one or more processors 104 are configured to perform an OSS compliance analyses, at step 216 (FIG. 2B) and block 318 (FIG. 3), for the one or more OSS components in the product under consideration based on the usage type identified at step 210 (FIG. 2A), the attributes associated thereof comprised in the second OSS database (DB2) and one or more pre-defined rules. Further, the one or more processors 104 are configured to generate a comprehensive report (R5), at step 218 (FIG. 2B) based on the OSS compliance analyses performed at step 216 (FIG. 26). In an embodiment, the comprehensive report (R5) includes a final attribute for each of the one or more OSS components in the product under consideration indicative of compliance with the attributes of each of the one or more OSS components comprised therein.

In an embodiment, an exemplary comprehensive report (R5) may be as represented in Table 3 below.

TABLE 3

| | | | | |
|---|---|---|---|---|
| OSS | o1 | o2 | o3 | o4 |
| Component | a | b | c | d |
| Version | 1.0 | 2.0 | 1.5 | 2.1 |
| Home Page | www.a.com | www.b.com | www.c.com | www.d.com |
| License | abc | bcd | enf | ghi |
| type | license | licese | licese | licese |
| License | www.abc.com | www.bcd.com | www.enf.com | www.ghi.com |
| URL | | | | |
| Usage | file | component | snippets | file |
| Distributable | yes | yes | yes | yes |
| Attribution | ©a.com | ©b.com | ©c.com | ©d.com |
| Note | | | | |

In an embodiment of the present disclosure, the step of performing an OSS compliance comprises firstly combining the first report (R1), the second report (R2), the third report (R3) and the fourth report (R4). The final attribute is then generated, wherein the pre-defined rules, in accordance with an embodiment of the present disclosure, may include:
Rule 1 wherein an OSS component is rejected if associated with the strong copy left license;
Rule 2 wherein an OSS component is approved for inclusion in the second OSS database (DB2) if associated with the weak copy left license and the OSS usage type is one of the library not compiled with the product or the file not compiled with the product;
Rule 3 wherein an OSS component is rejected if associated with the weak copy left license and the OSS usage type is the snippet;
Rule 4 wherein an OSS component is approved for inclusion in the second OSS database (DB2) if associated with the permissive license and the OSS usage is one of the library, the snippet or the file; and
Rule 5 wherein an OSS component is rejected if associated with the weak copy left license and the OSS usage type is one of the library compiled with the product or the file compiled with the product.

Further to Table 3 above, the final attribute in an exemplary comprehensive report (R5) may be generated as shown in Table 4 herein below.

TABLE 4

| | | | | |
|---|---|---|---|---|
| OSS | O1 | O2 | . . . | On |
| Commercialization (Com) | Y | Y | | N |
| (Yes(Y)), No (N) | | | | |
| Snippets (Snip) | Y | Y | | N |
| (Yes(Y)), No (N) | | | | |
| Modify (mod) | N | N | | N |
| (Yes(Y)), No (N) | | | | |
| File (Fil) | Y | N | | Y |
| (Yes(Y)), No (N) | | | | |
| Components (Static | Y | N | | Y |
| Library) (Comps) | | | | |
| (Yes(Y)), No (N) | | | | |
| Components (Dynamic | N | Y | | N |
| Library) (Compd) | | | | |
| (Yes(Y)), No (N) | | | | |
| Distribute with | N | Y | | Y |
| Proprietary code (DP) | | | | |
| (Yes(Y)), No (N) | | | | |
| Compile with | Y | N | | Y |
| Proprietary code (CP) | | | | |
| (Yes(Y)), No (N) | | | | |
| Final | O1ComY, O1SnipY, | O2ComY, O2SnipY, | | OnComN, OnSnipN, |
| attribute | O1ModN, O1FilY, | O2ModN, O2FilN, | | OnModN, OnFilY, |
| | O1CompsY, O1CompdN, | O2CompsN, O2CompdY, | | OnCompsY, OnCompdN, |
| | O1DPN, O1CPY | O2DPY, O2CPN | | OnDPY OnCPY |

When the final attribute values generated are “Y” for all the OSS components used in a product under consideration, it may be deemed as compliant with attributes of each of the one or more OSS components comprised therein and accordingly safe to use. The above mentioned attributes Commercialization (Com), Snippets(Snip), Modify (Mod) are primarily indicative of the attributes for Open source components used as part of software development; whereas the attributes File (Fil), Components (Static Library) (Comps), Components (Dynamic Library) (Compd) indicate how listed open source components may be used as part of software development. Again, the attributes Distribute with Proprietary code (DP), Compile with Proprietary code (CP) indicate whether the open source component can be compiled with proprietary product code (P1, P2 . . . Pn) and can be distributed with proprietary product code (P1, P2 . . . Pn).

In an embodiment, all the OSS components listed in the second OSS database (DB2) may have defined associated attributes as illustrated in tables herein above. For example Commercialization (Com) may be O1Com, Snippets (Snip) may be O1Snip, Modify (Mod) may be O1Mod, File (Fil) may be O1Fil, Components (Static Library) (Comps) may be O1Comps, Components (Dynamic Library) (Compd) may be O1Compd etc. Further the attributes of each OSS components may be Yes or No based on the determination of commercial usage applicability. For example, if Commercialization (Com) for O1 is Yes then the parameter may be O1ComY. If Commercialization (Com) for O1 is No, then the parameter may be O1ComN. Likewise for Snip, the values are O1 SnipY and O1SnipN, for Mod, the values are O1ModY and O1ModN, for Fil, the values are O1FilY and O1FilN, for Comps, the values are O1CompsY and O1CompsN, for Compd, the values are O1CompdY and O1CompdN etc.

Based on the final attribute generated, the system 100 determines which of the OSS components may be selected for deliverable. Further, there may be scenarios wherein some of the OSS components are compliant and can be part of a final deliverable but cannot be compiled. For example weak copyleft license (GNU lesser general public license, Sun Binary code license as like). In an embodiment, the system is configured to create a list of OSS components which may be compiled with proprietary code; and another set of OSS components which may be part of a final deliverable but may not be compiled.

In an embodiment, the system 100 is configured to define usage of open source components as Snippets (Snip), File (Fil), Components (Static Library) (Comps), Components (Dynamic Library) (Compd), Further the system 100 may be configured to determine if a component is modified. In an embodiment, if the usage is snippets (Snip) for any open source component, then the associated attribute is modification.

In an embodiment the second OSS database (DB2) may be updated with the one or more OSS components and associated attributes comprised in the comprehensive report (R5), at step 220 (FIG. 2) thereby enhancing the customized knowledge database via adaptive learning. It may be noted that the first time a product is received for analyzing the OSS components comprised therein, the second OSS database (DB2) may be empty. The adaptive learning updates the second OSS database (DB2) at step 214 (FIG. 2B).

Thus intelligence associated with the systems and methods of the present disclosure facilitate a matrix, by analyzing a set of OSS components (refer Table 2, Table 3 and Table 4 of DB2) to identify OSS components that may be compiled in a final deliverable and also facilitate the product owner to identify proprietary intellectual property that may be suitably protected and licensed without contamination by the accompanying OSS components in the product under consideration. An analysis of the OSS components and their attributes in consideration with the pre-defined rules ensure that inter-license compatibilities are checked and compliance with respect to compilation and distribution in a final deliverable is achieved, thereby ensuring that the OSS components retained in the final deliverable retain their intellectual property. For instance, a final deliverable may be P1 and/or P2 and/or . . . Pn while enforcing proprietary End User License Agreement (PEULA).

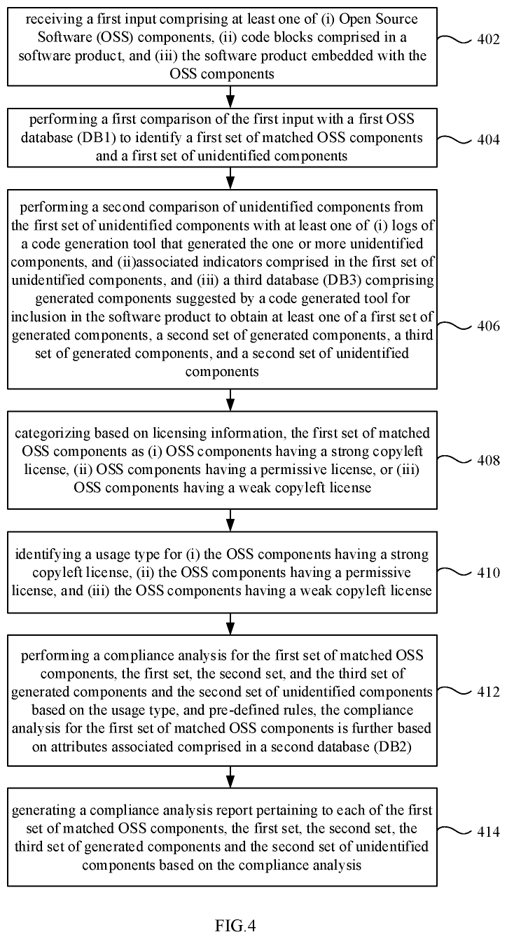

FIG. 4, with reference to FIGS. 1 through 3, depicts an exemplary flow chart illustrating a method for analyzing open source components, identifying generated components and proprietary components in software products, using the system 100 of FIG. 1, in accordance with an embodiment of the present disclosure. In an embodiment, the system(s) 100 comprises one or more data storage devices or the memory 102 operatively coupled to the one or more hardware processors 104 and is configured to store instructions for execution of steps of the method by the one or more processors 104. The steps of the method of the present disclosure will now be explained with reference to components of the system 100 of FIG. 1.

At step 402 of the method of the present disclosure, the one or more hardware processors 104 receive an input comprising at least one of (i) one or more Open Source Software (OSS) components, (ii) one or more code blocks comprised in a software product, and (iii) the software product embedded with the one or more OSS components. In other words, the input may be either only OSS component(s), code blocks from a software product, or the software product embedded with the one or more OSS components. The expression ‘software product’ may be referred as software systems delivered or made available as a service to consumers/end user with a documentation that describes how to install and/or use the system. In certain cases, software products may be part of system products where hardware, as well as software, is delivered or made available as a service to the end user. The input is received and is further to be analyzed for OSS compliance and also prevent OSS contamination of proprietary components. Different versions of a product P1, P2, . . . , Pn are received by the system 100 as input at step 402, in one embodiment of the present disclosure.

At step 404 of the method of the present disclosure, the one or more hardware processors 104 perform a first comparison of the first input with a first database (DB1) to identify a first set of matched OSS components and a first set of unidentified components. The system 100 further generates a first report (e.g., say R1) pertaining to the first set of matched OSS components, and a second report (e.g., say R2) pertaining to the first set of unidentified components.

The first database (DB1) may be available in the public domain or may be populated by the system 100 of the present disclosure based on OSS components available in the public domain. An exemplary public database DB1 with OSS components having exemplary attributes may be represented as shown in Table 5 herein below.

TABLE 5
(same as above DB1)

| | | | | |
|---|---|---|---|---|
| OSS | O1 | O2 | O3 | O4 |
| Component | Android-N810 | Android-Support | Android-Support | quartz-web |
| Version | | 4 | 4 | trunk-20120509-svn |
| Home Page | http://sourceforge.net/projects/ | http://developer.android.com/ | http://developer.android.com/ | http://code.google.comp/ |
| | android-n810/ | tools/support-library/ | tools/support-library/ | quartz-web/ |
| | | setup.html#download | setup.html#download | |
| License | Apache License 2.0 | Apache License 2.0 | Apache License 2.0 | dom4j License |
| Types | | | | (BSD 2.0+) |
| License | http://www.apache.org/licenses/ | http://www.apache.org/licenses/ | http://www.apache.org/ | http://dom4j.sourceforge.net/ |
| URL | LICENSE-2.0 | LICENSE-2.0 | licenses/LICENSE-2.0 | license.html |
| Usage | Component (Dynamic | File | Snippets | |
| | Library) | | | |
| Ship Status | Ship | Ship | Ship | |
| Attribution | Copyright (C) 2012 The | ©2004-2011 The | ©2004-2011 The | Copyright 2001-2010 |
| Note | Android Open Source | Apache Software | Apache Software | (C) MetaStuff |
| | [symbol] | [symbol] | [symbol] | |

| | | | | |
|---|---|---|---|---|
| OSS | O5 | O6 | O7 | O8 |
| Component | revertools | wpadk | xstream-1.3.1.jar | anhhoang |
| Version | | | 1.3.1 | trunk- [symbol] |
| Home Page | http://code.google.com/ | http://wpadk.codeplex.com/ | http://central.maven.org/ | http://code.google.com/ |
| | p/revertools/ | | maven2/com/thoughtworks/ | p/anhhoang/ |
| | | | xstream/xstream/1.3.1/ | |
| | | | xstream- | |
| License | MIT License | Oracle JRE 6 and | Public Domain | Eclipse Public |
| Types | | JavaFX Binary Code | | License 1.0 |
| | | Updated License | | |
| License | http://opensource.org/ | http://www.oracle.com/ | http://creativecommons.org/ | http://www.eclipse.org/ |
| URL | licenses/MIT | technetwork/java/javase/ | licenses/publicdomain/ | legal/epl-v10.html |
| | | downloads/jce-6-download- | | |
| | | 429243.html | | |
| Usage | | | | |
| Ship Status | | | | |
| Attribution | Copyright © by | Copyright © 1995- | Copyright(c) by | Copyright © by |
| Note | bollton2010 | 2016, Oracle | aopalliance | anhhoang1109 |
| | | | | [symbol] |

| | | | |
|---|---|---|---|
| OSS | O9 | O10 | O11 |
| Component | Coova JRadius | easyC | MySql |
| Version | 1.0.0 | secondglimpse | |
| Home Page | http://www.coova.org/ | http://sourceforge.net/ | https://www.mysql.com/ |
| | JRadius | projects/easyc/ | downloads/ |
| License | GNU Lesser | Eclipse Public | GPL |
| Types | General Public License | License 1.0 | |
| | v3.0 or later | | |
| License | http://www.gnu.org/licenses/ | http://www.eclipse.org/ | https://www.gnu.org/ |
| URL | lgpl-3.0.en.html | legal/epl-v10.html | licenses/gpl-3.0.en.html |
| Usage | | | |
| Ship Status | | | |
| Attribution | Copyright 2006- | Copyright © 2002- | ©2016, Oracle |
| Note | 2010 Coova | 2016. | [symbol] |

[symbol]

indicates data missing or illegible when filed

More specifically, at step 404 the first input (e.g., the at least one of (i) one or more Open Source Software (OSS) components, (ii) one or more code blocks comprised in a software product, and (iii) the software product embedded with the one or more OSS components) is compared with OSS components available/comprise in the first database DB1 to identify one or more matches therebetween based on component attributes and license attributes associated thereof. Additionally, if no match is found, then such components are referred as a first set of unidentified components.

At step 406 of the method of the present disclosure, the one or more hardware processors 104 perform a second comparison of one or more unidentified components from the first set of unidentified components with at least one of (i) one or more logs of a code generation tool that generated the one or more unidentified components, and (ii) one or more associated indicators comprised in the first set of unidentified components, and (iii) a third database (DB3) comprising one or more generated components suggested by a code generated tool for inclusion in the software product to obtain at least one of a first set of generated components, a second set of generated components, a third set of generated components and a second set of unidentified components. The first set of generated components, the second set of generated components, and the third set of generated components include but are not limited to, data types such as text (alphanumeric, multilingual), code, images, audio, video, 3d models and robotic actions which may be included in the software product. In Generative AI terminology, AI Generated Contents may be called as output, responses, suggestions, completions, and so on.

Example of log of the code generation tool is as below: 2023-09-21 13:07:20,349 INFO—Thread-11: MainProces:apps.knowledge_manag:vector_engine:indexer:0623 Generating code block for provided condition, marked with 35zmh4jrkjocgray4xmpdzdwftrw51co, completed in: 119.39860 secs

Example of source code Comments, with identifier, hash value:

// Following code block generated for checking whether branch
information provided or not.
// Block start: 35zmh4jrkjocgray4xmpdzdwftrw51co...
//Block End: 35zmh4jrkjocgray4xmpdzdwftrw51co

Examples of Citation Information:

The generated response has elements that are source from: 1. Reference 1, Link1 2. 1. Reference 2, Link2, and so on.

The system 100 may be trained or assisted by one or more artificial intelligence (AI) methodologies as known in the art for detecting the indicators or text from the indicators (are from the developer) and interpret the intent from the indicators or text from the indicators.

The system 100 further generates a third report (e.g., say R3) pertaining to the first set of generated components, and a fourth report (e.g., say R4) for the second set of unidentified components, and a fifth report (R5) for the third set of generated components.

The code generation tool comprises at least one of a generative artificial intelligence (AI) model, a model-driven generation tool, and a grammar-driven generation tool. Examples of such tools or models may comprise, but are not limited to, (i) Model-Driven Development (MDD) tool, (ii) Template, Rule, Grammar or Annotation based generation tool, (iii) Domain-Specific Language (DSL) based generators, (iv) Application Builders and Low Code No Code platforms, (v) Generative AI and Code Completion technologies, (vi) Code synthesis from Diagrams, (vii) Code scaffoldings & Frameworks, and so on.

At step 408 of the method of the present disclosure, the one or more hardware processors 104 categorize based on licensing information, the first set of matched OSS components as (i) OSS components having a strong copyleft license, (ii) OSS components having a permissive license, or (iii) OSS components having a weak copyleft license. In an embodiment, the one or more OSS components having a match with the OSS components available in the first database (DB1) are categorized based on associated attributes. In an embodiment the various categories may include (i) OSS components having strong copyleft license such as General Public License (GPL) or Affero General Public License (AGPL) (ii) permissive license such as Massachusetts Institute of Technology (MIT) License or Apache or (iii) weak copyleft or free public license such as Lesser General Public License (LGPL), Mozilla Public License (MPL), Eclipse Public License (EPL) and the like.

A report for each categorization is generated by the system 100, in one embodiment of the present disclosure. For instance, (i) a sixth report (R6) is generated for OSS components having the strong copyleft license, (ii) a seventh report (R7) is generated for OSS components having the permissive license, and (iii) a eighth report (R8) is generated for OSS components having the weak copyleft license.

At step 410 of the method of the present disclosure, the one or more hardware processors 104 identify a usage type for (i) the OSS components having a strong copyleft license, (ii) the OSS components having a permissive license, and (iii) the OSS components having a weak copyleft license. In an embodiment, the license usage type may be one of a code block, a snippet, a file, or a library. Further, the OSS usage type of the one or more OSS components is defined as snippets (Snip), file (Fil), a Static library (Comps), a dynamic library(Compd), and it is determined if a component is modified. When the usage type is the snippets (Snip) for the OSS component then the component to have attribute of modification, and the snippets (Snip) is indicative of one or more attributes for the one or more OSS components used as part of software development. The Static library (Comps) and the dynamic library (Compd) are indicative of one or more listed open source components being used as part of software development. The library may be further identified as one of a library-executable or a library-binary type, in one embodiment of the present disclosure.

At step 412 of the method of the present disclosure, the one or more hardware processors 104 perform a compliance analysis for the first set of matched OSS components, and at least one of the first set of generated components, the second set of generated components, the third set of generated components and the second set of unidentified components based on the usage type, and one or more pre-defined rules. The compliance analysis for the first set of matched OSS components is further based on one or more attributes associated thereof comprised in a second database (DB2). In an embodiment, the second database (DB2) having exemplary attributes may be represented as shown in Table 6 herein below.

TABLE 6
(same as above DB2)

| | | | | |
|---|---|---|---|---|
| OSS | O1 | O2 | O3 | O4 |
| Component | hibernatecommonsannotations.jar | hibernatecommonsannotations.c | hibernatecommonsannotations.c | mchange-commons- |
| | | | | java |
| Version | | | | 0.2.2 |
| Home Page | http://central.maven.org/ | http://central.maven.org/ | http://central.maven.org/ | http://github.com/ |
| | maven2/org/hibernate/ | maven2/org/hibernate/ | maven2/org/hibernate/ | swaldman/mchange- |
| | hibernate-commons-annotations/ | hibernate-commons-annotations/ | hibernate-commons-annotations/ | commons-java/ |
| | 3.3.0.ga/hibernate-commons- | 3.3.0.ga/hibernate-commons- | 3.3.0.ga/hibernate-commons- | |
| | annotations-3.3.0.ga.pom | annotations-3.3.0.ga.pom | annotations-3.3.0.ga.pom | |
| License | GNU Lesser General Public | GNU Lesser General Public | GNU Lesser General Public | General public |
| type | License v3.0 or later | License v3.0 or later | License v3.0 or later | license |
| License | http://www.gnu.org/licenses/ | http://www.gnu.org/licenses/ | http://www.gnu.org/licenses/ | http://www.gnu.org/ |
| URL | lgpl-3.0.en.html | lgpl-3.0.en.html | lgpl-3.0.en.html | licenses/lgpl-2.1.html |
| Usage | Component (Dynamic Library) | File | Snippets | Component (Dynamic |
| | | | | Library) |
| Distributable | Yes | Yes | No | No |
| Attribution | Copyright (c) 2008, Red Hat | Copyright (c) 2008, Red Hat | Copyright (c) 2008, Red | Copyright (C) 1991, |
| Note | Middleware LLC | Middleware LLC | Hat Middleware LLC | 1999 Free Software |
| | | | | Foundation, [symbol] |
| Compile | No | No | No | No |
| License | Yes | No | No | No |
| compatibility | | | | |
| with proprietary | | | | |
| license/code | | | | |

| | | | | |
|---|---|---|---|---|
| OSS | O5 | O6 | O7 | O8 |
| Component | mchange-commons.Jar | Mchange.Jar | JackRabit.jar | JackRabit.jar |
| Version | 0.2.2 | 0.2.2 | 01 | 01 |
| Home Page | http://github.com/swaldman/ | http://github.com/swaldman/ | https://apachekackrabit.com | https://apachekackrabit.com |
| | mchange-commons-java/ | mchange-commons-java/ | | |
| License | General public license | General public license | Apache license | Apache license |
| type | | | | |
| License | http://www.gnu.org/licenses/ | http://www.gnu.org/licenses/ | https://www.apache.org/licenses/ | https://www.apache.org/licenses/ |
| URL | lgpl-2.1.html | lgpl-2.1.html | LICENSE-2.0 | LICENSE-2.0 |
| Usage | File | Snippets | Component | File |
| Distributable | No | NO | Yes | Yes |
| Attribution | Copyright (C) 1991, 1999 | Copyright (C) 1991, 1999 | ©jackrabbit | ©jackrabbit |
| Note | Free Software Foundation, [symbol] | Free Software Foundation, [symbol] | | |
| Compile | No | No | Yes | Yes |
| License | No | No | Yes | Yes |
| compatibility | | | | |
| with proprietary | | | | |
| license/code | | | | |

| | | | | |
|---|---|---|---|---|
| OSS | O9 | O10 | O11 | O12 |
| Component | JackRabit.jar | Firefox.jar | Flipbox.java | Flipbox.c |
| Version | 01 | 11 | 11 | 11 |
| Home Page | https://apachekackrabit.com | Firefox.com | Flipbox.com | Flipbox.com |
| License | Apache license | Mozilla license | Mozilla license | Mozilla license |
| type | | | | |
| License | https://www.apache.org/ | https://en.wikipedia.org/ | https://en.wikipedia.org/ | https://en.wikipedia.org/ |
| URL | licenses/LICENSE-2.0 | wiki/Mozilla_Public_License | wiki/Mozilla_Public_License | wiki/Mozilla_Public_License |
| Usage | Snippet | Component | File | File |
| Distributable | Yes | Yes | No | No |
| Attribution | ©jackrabbit | ©Mozilla | ©Flipbox | ©Flipbox |
| Note | | | | |
| Compile | Yes | Yes | No | No |
| License | Yes | Yes | No | No |
| compatibility | | | | |
| with proprietary | | | | |
| license/code | | | | |

[symbol]

indicates data missing or illegible when filed

It is to be understood by a person having ordinary skill in the art that rules may vary depending upon the project type, dependency scenario, license usage type, and license attributes. For instance, if dependency scenario is that software is to be packaged and distributed as part of Customer Delivery or as an IP asset (product/solution), and some of the exemplary rules can be applied as follows: A final attribute is then generated based on the pre-defined rules, wherein the pre-defined rules can be configured, in accordance with an embodiment of the present disclosure, and may include:

Rule 1 wherein an OSS component is rejected if associated with the strong copy left license;
Rule 2 wherein an OSS component is approved for inclusion in the second OSS database (DB2) if associated with the weak copy left license and the OSS usage type is one of the library not compiled with the product or the file not compiled with the product;
Rule 3 wherein an OSS component is rejected if associated with the weak copy left license and the OSS usage type is the snippet;
Rule 4 wherein an OSS component is approved for inclusion in the second OSS database (DB2) if associated with the permissive license and the OSS usage is one of the library, the snippet or the file; and
Rule 5 wherein an OSS component is rejected if associated with the weak copy left license and the OSS usage type is one of the library compiled with the product or the file compiled with the product.

In an embodiment, all the OSS components listed in the second database (DB2) may have defined associated attributes. For example, Commercialization (Com) may be O1Com, Snippets (Snip) may be O1Snip, Modify (Mod) may be O1Mod, File (Fil) may be O1Fil, Components (Static Library) (Comps) may be O1Comps, Components (Dynamic Library) (Compd) may be O1Compd etc. Further the attributes of each OSS components may be Yes or No based on the determination of commercial usage applicability. For example, if Commercialization (Com) for O1 is Yes then the parameter may be O1ComY. If Commercialization (Com) for O1 is No, then the parameter may be O1Com N. Likewise for Snip, the values are O1 SnipY and O1SnipN, for Mod, the values are O1ModY and O1ModN, for Fil, the values are O1FilY and O1FilN, for Comps, the values are O1CompsY and O1CompsN, for Compd, the values are O1CompdY and O1CompdN, etc.

Additionally, all the OSS components listed in the second database (DB2) may have further associated attributes. For example, these further associated attributes may include, but are not limited to, license usage type, Dependency Scenarios such as research/study, building/editing/testing, packaging, production and the like, and project type such as customer service delivery, internal applications, software assets codifying intellectual property and the like. Each of the OSS components is also tagged to license types which may also have associated attributes such as usage, distribution, derivation, invocation, rights and obligations and so on.

Based on the final attribute (or recommendation) generated, the system 100 determines which of the OSS components may be selected for the software product (which can be dependent on the project type, dependency, scenario, license usage type, and license attributes present in the permission matrix comprised in the second database DB2). Further, there may be scenarios wherein some of the OSS components are compliant and can be part of a final deliverable but cannot be compiled, for example, weak copyleft license (GNU lesser general public license, Sun Binary code license as like). In an embodiment, the system is configured to create a list of OSS components which may be compiled with proprietary code; and another set of OSS components which may be part of a final deliverable but may not be compiled.

For the sake of brevity, only few attributes are depicted in the above Table 2, however additional attributes as described above also are (or may also be) part of DB2.

It is to be noted that the second database (DB2) has a pre-defined format comprising the attributes including OSS component name, OSS component version, OSS component home page URL, OSS component license type, OSS component license URL, OSS component attribution note, license usage type, commercial distribution permission, and OSS component compile permission, license compatibility with the OSS component license type associated with other OSS components comprised in the product or compatibility with proprietary license.

An exemplary permission matrix may be represented as shown in Table 7 herein below.

TABLE 7

| | | | | | | Build/ |
|---|---|---|---|---|---|---|
| | License uniform resource | License | | Research/ | Package | editing/ |
| License | locator | type | Usage remarks | study | software | testing |
| Academic Free | https://opensource.org/ | Permissive | | ✓ | ✓ | ✓ |
| License 3.0 (AFL-3.0) | license | | | | | |
| | [symbol] | | | | | |
| Affero General Public | http://www.affero.org/ | Strong | Not allowed for combining or use | ✓ | x | ✓ |
| License (by Affero) | oagpl.ht | Copyleft | with proprietary software. | | | |
| v1.0 (AGPL-1.0) | [symbol] | | | | | |
| Affero General Public | https://gnu.org/licenses/ | Strong | Not allowed for combining or use | ✓ | x | ✓ |
| License (by GNU) | agpl.html | Copyleft | with proprietary software. | | | |
| v3.0 (AGPL-3.0) | | | | | | |
| Amazon software | http://aws.amazon.com/asl/ | Proprietary | Limitation to use ONLY with web | * | * | * |
| License | | Free | services, computing platforms or | | | |
| | | | [symbol] | | | |
| Amazon WorkSpaces | https://clients.amazonworkspa | Proprietary | Only meant for Personal purpose | * | * | * |
| Application License | [symbol] | Free | and ONLY with Amazon services, | | | |
| Agreement | | | [symbol] | | | |
| ANTLR 2 License | https://www.antlr2.org/ | Strong | | ✓ | x | ✓ |
| | license. | Copyleft | | | | |
| | [symbol] | | | | | |
| ANTLR 4 License | http://www.antlr.org/ | Permissive | | ✓ | ✓ | ✓ |
| | license.ht | | | | | |
| | [symbol] | | | | | |
| Apache License | http://www.apache.org/ | Permissive | 1. Using this requires specific | ✓ | * | ✓ |
| Version 1.0 | license/LICENSE-1.0 | | acknowledgements to be included | | | |
| | | | in end-user document. See license | | | |
| | | | text for more information. | | | |
| Apache License | http://www.apache.org/ | Weak | Modifications would need to be | ✓ | * | ✓ |
| Version 2.0 | license | Copyleft | released under Apache 2.0 as well | | | |
| | [symbol] | | | | | |

| | | | | | | | Intellectual | | |
|---|---|---|---|---|---|---|---|---|---|
| | | Company ABC (internal) | | | | | Property (IP) Asset | | |
| | Customer | | | Build/ | | | | Build/ | |
| | project | Research/ | Package | editing/ | | Research/ | | editing/ | |
| License | Production | stud | software | testing | Production | study | Packag | testing | Production |
| Academic Free | ✓ | ✓ | ✓ | ✓ | ✓ | ✓ | ✓ | ✓ | ✓ |
| License 3.0 (AFL-3.0) | | | | | | | | | |
| Affero General Public | x | ✓ | ✓ | ✓ | ✓ | ✓ | x | ✓ | * |
| License (by Affero) | | | | | | | | | |
| v1.0 (AGPL-1.0) | | | | | | | | | |
| Affero General Public | x | ✓ | ✓ | ✓ | ✓ | ✓ | x | ✓ | x |
| License (by GNU) | | | | | | | | | |
| v3.0 (AGPL-3.0) | | | | | | | | | |
| Amazon software | * | * | * | * | * | * | * | * | * |
| License | | | | | | | | | |
| Amazon WorkSpaces | * | * | * | * | * | * | * | * | * |
| Application License | | | | | | | | | |
| Agreement | | | | | | | | | |
| ANTLR 2 License | x | ✓ | ✓ | ✓ | ✓ | ✓ | x | ✓ | x |
| ANTLR 4 License | ✓ | ✓ | ✓ | ✓ | ✓ | ✓ | ✓ | ✓ | ✓ |
| Apache License | * | ✓ | ✓ | ✓ | * | ✓ | ✓ | ✓ | * |
| Version 1.0 | | | | | | | | | |
| Apache License | * | ✓ | ✓ | ✓ | ✓ | ✓ | * | ✓ | * |
| Version 2.0 | | | | | | | | | |

[symbol]

indicates data missing or illegible when filed

In the above Table 7, symbols ‘✓’ refers to ‘allowed’, ‘x’ refers to ‘not allowed’, and ‘*’ refers to ‘conditionally allowed’. These symbols serve as flags such as permission flag indicating at least one of an allowed flag, a not allowed flag, and a conditionally allowed flag pertaining to the associated dependency scenario and the associated project type. The system 100 generates recommendations for (i) the allowed flag, (ii) the conditionally allowed flag, and one or more guidelines are generated for each of the plurality of OSS components with respect to one or more license obligations and restrictions for allowed flag and conditionally allowed flag, and (iii) one or more associated reasons for the not allowed flag. A recommendation report is (or may be) generated comprising at least one of a name of OSS component, a version of OSS component, a Uniform Resource Locator (URL) for OSS, an Applicable OSS License, License Type, a URL for OSS License, a Project Type, a dependency scenario, the one or more guidelines, and one or more recommendations for conditionally allowed flags.

At step 414 of the method of the present disclosure, the one or more hardware processors 104 generating a compliance analysis report pertaining to each of the first set of matched OSS components, and at least one of the first set of generated components, the second set of generated components, the third set of generated components and the second set of unidentified components based on the compliance analysis. For instance, a nineth report (R9) is generated for the first set of matched OSS components, a tenth report (R10) is generated for the first set of generated components, a eleventh report (R11) is generated for the second set of generated components, a twelfth report (12) for the third set of generated components and a thirteen report (R13) is generated for the second set of unidentified components. It is to be understood by a person having ordinary skill in the art that the system 100 may generate a single comprehensive compliance analysis report (e.g., say R′) that has information pertaining to the first set of matched OSS components, the first set of generated components and the second set of unidentified components, and such report generation shall not be construed as limiting the scope of the present disclosure.

The one or more hardware processors 104 further update the second database (DB2) with the first set of matched OSS components. In other words, the second database (DB2) is updated with the one or more OSS components and associated attributes comprised in the comprehensive report, thereby enhancing the customized knowledge database via adaptive learning. It may be noted that the first time a product is received for analyzing the OSS components comprised therein, the second database (DB2) may be empty. The adaptive learning updates the second database.

Similarly, the one or more hardware processors 104 further populates a third database (DB3) with at least one of: (i) the first set of generated components, and (ii) the second set of generated components, (iii) the third set of generated components and (iv) one or more generated components suggested by the code generated tool and accepted for inclusion in the software product. The one or more generated components suggested by the code generated tool and accepted for inclusion in the software product are detected during a software product development, in one embodiment of the present disclosure. Upon populating the third database (DB3), the one or more hardware processors 104 may perform a third comparison of the first set of unidentified components with the third database (DB3) is performed to identify a fourth set of generated components, and a third set of unidentified components. The third comparison may be performed as an alternative to the second comparison performed in 406, in one embodiment of the present disclosure. The system 100 further generates a report (e.g., say a fourteen report R14) for the second set of generated components and a thirteen report (R15) for the third set of unidentified components.

The method of the present disclosure further includes a step wherein the one or more hardware processors 104 perform a fourth comparison of one or more unidentified components from the third set of unidentified components with at least one of (i) the one or more logs of the code generation tool that generated the one or more unidentified components, and (ii) the one or more associated indicators comprised in the third set of unidentified components, to obtain a fifth set of generated components and a fourth set of unidentified components. As done in step 406, similar comparison is performed herein between the third set of unidentified components with at least one of (i) the one or more logs of the code generation tool that generated the one or more unidentified components, and (ii) the one or more associated indicators comprised therein. The system 100 further generates a report (e.g., say fifteen report R15) for the third set of generated components, and a sixteen report (R16) for the fourth set of unidentified components. The expressions ‘third set of unidentified components’ and ‘fourth set of unidentified components’ are referred to as ‘proprietary components’ or human generated components (e.g., components authored by human developer) and interchangeably used herein.

Further, the method of FIG. 2 includes detecting, via the one or more hardware processors 104, during a software product development, a dependency scenario, and a project type for one or more associated OSS components and querying the first database (DB1) to update the second database (DB2) with information relating to license and usage type of OSS components.

There may be scenarios wherein the software product is still under development. In such scenarios, the method of the present disclosure generates in real-time, the one or more recommendations, and the one or more guidelines for each of the plurality of OSS components with respect to one or more license obligations and restrictions. The one or more guidelines may include but are not limited to Do's and Don'ts pertaining to each license-usage combination. A recommendation report is generated that comprises of a name of OSS component, version of OSS component, URL for OSS, applicable OSS license, license type, URL for OSS license, project type, dependency scenario (e.g., build/editing/testing, and so on), guidelines in the form of Do's and Don'ts, and any further recommendations for conditionally allowed flags.

When the software product is under development, there could be OSS components added as a dependency. In such scenarios, the one or more hardware processors 104 detects a dependency scenario, a project type, and then queries the DB1 to update DB2 with information relating to license type, and license usage type and so on and then query the DB2 to provide one or more recommendations. Additionally, the system 100 can be configured to check whether the OSS components added as the dependency can be used or not for software product development with other OSS components in the software product. This ensures that during the software product development the developer is provided guidance on use of such OSS components, license information, and their interoperability/compatibility and also saves developer's overall time and effort required for development of the software product. Further, the system 100 detects (or may detect), during a software product development, one or more generated components suggested by the code generated tool and accepted for inclusion in the software product, and a third database (DB3) is populated with the one or more generated components suggested by the code generated tool.

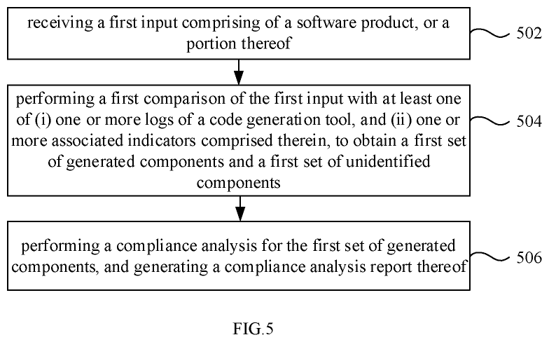

FIG. 5, with reference to FIGS. 1-4, depicts an exemplary flow chart illustrating a method for analyzing open source components, identifying generated components and proprietary components in software products, using the system 100 of FIG. 1, in accordance with an embodiment of the present disclosure. In an embodiment, the system(s) 100 comprises one or more data storage devices or the memory 102 operatively coupled to the one or more hardware processors 104 and is configured to store instructions for execution of steps of the method by the one or more processors 104. The steps of the method of the present disclosure will now be explained with reference to components of the system 100 of FIG. 1.

At step 502 of the method of the present disclosure, the one or more hardware processors 104 receive a first input comprising of a software product, or a portion thereof. In other words, the input may be either an entire software product, or a portion of the software product. The input may comprise OSS components and/or code blocks as received in step 402 of FIG. 4.

At step 504 of the method of the present disclosure, the one or more hardware processors 104 perform a first comparison of the first input with at least one of (i) one or more logs of a code generation tool, and (ii) one or more associated indicators comprised therein, to obtain a first set of generated components and a first set of unidentified components. Similar to how comparison was done in step 406 of FIG. 4, the one or more hardware processors 104 perform the comparison of the input with logs of the code generation tool and/or associated indicators comprised in the input. Based on the first comparison, the system 100 generates a first report (R1′) for the first set of generated components, and a second report (R2′) for the first set of unidentified components.

At step 506 of the method of the present disclosure, the one or more hardware processors 104 perform a compliance analysis for the first set of generated components with the help of the first report (R1′) and generate a compliance analysis report thereof (e.g., say third report R3′).

Once the first set of unidentified components at step 504, these unidentified components are further compared with the first database (DB1). In other words, the one or more hardware processors 104 perform a second comparison of the first set of unidentified components with the first database (DB1) to identify a first set of matched OSS components and a second set of unidentified components. The system 100 further generates a fourth report R4′ for the first set of matched OSS components and a fifth report R5′ for the second set of unidentified components.

Based on the licensing information, the first set of matched OSS components are categorized as (i) OSS components having a strong copyleft license, (ii) OSS components having a permissive license, or (iii) OSS components having a weak copyleft license. The above step of categorization is similar to step 408 of FIG. 4. Further, a usage type for (i) the OSS components having a strong copyleft license, (ii) the OSS components having a permissive license, and (iii) the OSS components having a weak copyleft license is identified. The identification of the usage type of above step is similar to step 410 of FIG. 4.

The method of the FIG. 3 further includes a step of performing a compliance analysis for the first set of matched OSS components and the second set of unidentified components based on the usage type, and one or more pre-defined rules. The compliance analysis for the first set of matched OSS components is further based on one or more attributes associated thereof comprised in the second database (DB2) the attributes are described above which also have other attributes that are part of the permission matrix. The system 100 further generates a compliance analysis report pertaining to each of the first set of matched OSS components, and the second set of unidentified components based on the compliance analysis. For instance, the system 100 generates a sixth report (R6′) for the first set of matched OSS components and a seventh report (R7′) for the second set of unidentified components based on the compliance analysis. It is to be understood by a person having ordinary skill in the art that all of the above databases and the tables as described herein are updated and stored in the memory 102 as applicable.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method comprising:
receiving a first input comprising at least one of (i) one or more Open Source Software (OSS) components, (ii) one or more code blocks comprised in a software product, and (iii) the software product embedded with the one or more OSS components;
performing a first comparison of the first input with a first database (DB1) to identify a first set of matched OSS components and a first set of unidentified components;
performing a second comparison of one or more unidentified components from the first set of unidentified components with at least one of (i) one or more logs of a code generation tool that generated the one or more unidentified components, (ii) one or more associated indicators comprised in the first set of unidentified components, and (iii) a third database (DB3) comprising one or more generated components, to obtain at least one of a first set of generated components, a second set of generated components, a third set of generated components, and a second set of unidentified components;
categorizing based on licensing information, the first set of matched OSS components as (i) OSS components having a strong copyleft license, (ii) OSS components having a permissive license, or (iii) OSS components having a weak copyleft license;
identifying a usage type for (i) the OSS components having a strong copyleft license, (ii) the OSS components having a permissive license, and (iii) the OSS components having a weak copyleft license;
performing a compliance analysis for the first set of matched OSS components, and at least one of the first set of generated components, the second set of generated components, the third set of generated components and the second set of unidentified components based on the usage type, and one or more pre-defined rules, wherein the compliance analysis for the first set of matched OSS components is further based on one or more attributes associated thereof comprised in a second database (DB2); and
generating a compliance analysis report pertaining to each of the first set of matched OSS components, and at least one of the first set of generated components, the second set of generated components, the third set of generated components, and the second set of unidentified components based on the compliance analysis.

2. The processor implemented method of claim 1, further comprising updating the second database (DB2) with the first set of matched OSS components.

3. The processor implemented method of claim 1, further comprising populating the third database (DB3) with at least one of (i) the first set of generated components, and (ii) the second set of generated components, (iii) the third set of generated components and (iv) one or more generated components suggested by the code generated tool and accepted for inclusion in the software product.

4. The processor implemented method of claim 3, wherein a third comparison of the first set of unidentified components with the third database (DB3) is performed to identify a fourth set of generated components, and a third set of unidentified components.

5. The processor implemented method of claim 4, further comprising performing a fourth comparison of one or more unidentified components from the third set of unidentified components with at least one of (i) the one or more logs of the code generation tool that generated the one or more unidentified components, and (ii) the one or more associated indicators comprised in the third set of unidentified components, to obtain a fifth set of generated components and a fourth set of unidentified components.

6. The processor implemented method of claim 1, wherein the code generation tool comprises at least one of a generative artificial intelligence (AI) model, a model-driven generation tool, and a grammar-driven generation tool.

7. The processor implemented method of claim 1, wherein the one or more generated components suggested by the code generated tool and accepted for inclusion in the software product are detected during a software product development.

8. The processor implemented method of claim 1, further comprising detecting during a software product development, a dependency scenario, and a project type for one or more associated OSS components and querying the first database (DB1) to update the second database (DB2) with information relating to license and usage type of OSS components and further querying the second database (DB2) for providing one or more recommendations.

9. A processor implemented method comprising:
receiving an input comprising of a software product, or a portion thereof;
performing a first comparison of the first input with at least one of (i) one or more logs of a code generation tool, and (ii) one or more associated indicators comprised therein, to obtain a first set of generated components and a first set of unidentified components; and
performing a compliance analysis for the first set of generated components and generating a compliance analysis report thereof.

10. The processor implemented method of claim 9, further comprising:
performing a second comparison of the first set of unidentified components with a first database (DB1) to identify a first set of matched OSS components and a second set of unidentified components;
categorizing based on licensing information, the first set of matched OSS components as (i) OSS components having a strong copyleft license, (ii) OSS components having a permissive license, or (iii) OSS components having a weak copyleft license;
identifying a usage type for (i) the OSS components having a strong copyleft license, (ii) the OSS components having a permissive license, and (iii) the OSS components having a weak copyleft license;
performing a compliance analysis for the first set of matched OSS components and the second set of unidentified components based on the usage type, and one or more pre-defined rules, wherein the compliance analysis for the first set of matched OSS components is further based on one or more attributes associated thereof comprised in a second database (DB2); and
generating a compliance analysis report pertaining to each of the first set of matched OSS components, and the second set of unidentified components based on the compliance analysis.

11. The processor implemented method of claim 9, wherein the code generation tool comprises at least one of a generative artificial intelligence (AI) model, a model-driven generation tool, and a grammar-driven generation tool.

12. A system comprising:
a memory storing instructions;
one or more communication interfaces; and
one or more hardware processors coupled to the memory via the one or more communication interfaces, wherein the one or more hardware processors are configured by the instructions to:
receive a first input comprising at least one of (i) one or more Open Source Software (OSS) components, (ii) one or more code blocks comprised in a software product, and (iii) the software product embedded with the one or more OSS components;
perform a first comparison of the first input with a first database (DB1) to identify a first set of matched OSS components and a first set of unidentified components;
perform a second comparison of one or more unidentified components from the first set of unidentified components with at least one of (i) one or more logs of a code generation tool that generated the one or more unidentified components, and (ii) one or more associated indicators comprised in the first set of unidentified components, and (iii) a third database (DB3) comprising one or more generated components to obtain at least one of a first set of generated components, a second set of generated components, a third set of generated components and a second set of unidentified components;
categorize based on licensing information, the first set of matched OSS components as (i) OSS components having a strong copyleft license, (ii) OSS components having a permissive license, or (iii) OSS components having a weak copyleft license;
identify a usage type for (i) the OSS components having a strong copyleft license, (ii) the OSS components having a permissive license, and (iii) the OSS components having a weak copyleft license;
perform a compliance analysis for the first set of matched OSS components, and at least one of the first set of generated components, the second set of generated components, the third set of generated components and the second set of unidentified components based on the usage type, and one or more pre-defined rules, wherein the compliance analysis for the first set of matched OSS components is further based on one or more attributes associated thereof comprised in a second database (DB2); and
generate a compliance analysis report pertaining to each of the first set of matched OSS components, and at least one of the first set of generated components, the second set of generated components, the third set of generated components and the second set of unidentified components based on the compliance analysis.

13. The system of claim 12, wherein the one or more hardware processors are further configured by the instructions to update the second database (DB2) with the first set of matched OSS components.

14. The system of claim 12, wherein the one or more hardware processors are further configured by the instructions to populate a third database (DB3) with at least one of the first set of generated components, the second set of generated components, the third set of generated components, and the one or more generated components suggested by the code generated tool and accepted for inclusion in the software product.

15. The system of claim 12, wherein a third comparison of the first set of unidentified components with the third database (DB3) is performed to identify a fourth set of generated components, and a third set of unidentified components.

16. The system of claim 15, wherein the one or more hardware processors are further configured by the instructions to perform a fourth comparison of one or more unidentified components from the third set of unidentified components with at least one of (i) the one or more logs of the code generation tool that generated the one or more unidentified components, and (ii) the one or more associated indicators comprised in the third set of unidentified components, to obtain a fifth set of generated components and a fourth set of unidentified components.

17. The system of claim 12, wherein the code generation tool comprises at least one of a generative artificial intelligence (AI) model, a model-driven generation tool, and a grammar-driven generation tool.

18. A system comprising:
a memory storing instructions;
one or more communication interfaces; and
one or more hardware processors coupled to the memory via the one or more communication interfaces, wherein the one or more hardware processors are configured by the instructions to:
receive an input comprising of a software product, or a portion thereof;
perform a first comparison of the first input with at least one of (i) one or more logs of a code generation tool, and (ii) one or more associated indicators comprised in the first input, to obtain a first set of generated components, a second set of generated components, and a first set of unidentified components; and
perform a compliance analysis for the first set of generated components, and the second set of generated components, and generating a compliance analysis report thereof.

19. The system of claim 18, wherein the one or more hardware processors are further configured by the instructions to:
perform a second comparison of the first set of unidentified components with a first database (DB1) to identify a first set of matched OSS components and a second set of unidentified components;
categorize based on licensing information, the first set of matched OSS components as (i) OSS components having a strong copyleft license, (ii) OSS components having a permissive license, or (iii) OSS components having a weak copyleft license;
identify a usage type for (i) the OSS components having a strong copyleft license, (ii) the OSS components having a permissive license, and (iii) the OSS components having a weak copyleft license;
perform a compliance analysis for the first set of matched OSS components and the second set of unidentified components based on the usage type, and one or more pre-defined rules, wherein the compliance analysis for the first set of matched OSS components is further based on one or more attributes associated thereof comprised in a second database (DB2); and
generate a compliance analysis report pertaining to each of the first set of matched OSS components, and the second set of unidentified components based on the compliance analysis.

20. The system of claim 18, wherein the code generation tool comprises at least one of a generative artificial intelligence (AI) model, a model-driven generation tool, and a grammar-driven generation tool.
